(19) United States
(12) Patent Application Publication
(10) Pub. No.: US 2018/0344091 A1
(43) Pub. Date: Dec. 6, 2018

(54) Grinding Machine

(71) Applicant: Mannarsamy Balasubramanian, Roswell, GA (US)

(72) Inventor: Mannarsamy Balasubramanian, Roswell, GA (US)

(21) Appl. No.: 15/608,994

(22) Filed: May 30, 2017

(51) Int. Cl. A47J 43/08; A47J 43/06; A47J 43/046

(52) U.S. Cl. CPC A47J 43/08; A47J 43/046; A47J 43/085; A47J 43/06

(57) ABSTRACT

A multi-purpose food grinding machine having springs for exerting compressive force upon grinding rollers having various surfaces and configurations and including apparatus for adjusting and monitoring the compressive force.

### CROSS-REFERENCE TO RELATED APPLICATION

This is a continuation-in-part of U.S. patent application Ser. No. 14/160,513, filed on Jan. 21, 2014 and now U.S. Pat. No. 9,662,657, granted on May 30, 2017.

### BACKGROUND OF THE INVENTION

Commercially available grinding machines for use in conching of cocoa paste, nut paste, and shear sensitive biological products, herbal products, etc., are extremely huge machines that require heavy stone rollers. Such machines were made for very large scale chocolate production. There was no temperature control module to control the temperature of the chocolate paste. The temperature of the paste depended upon various external conditions that could not be controlled or maintained. The chemical and physical transformations that occur during the grinding and conching processes depend upon the grinding temperature that is not actively controlled.

In conventional grinders, cylindrical wheels rotate over the flat surface of a circular bottom disc. In this design, the linear velocity of the areas closest to the center of the disc is different from the areas farther from the center as shown in FIG. 2. The linear surface velocity increases from center to the edge of the flat surface. When cylindrical roller stones are allowed to rotate over flat surface, for example, in conventional chocolate melangers, there is a drag and higher sheer action at both edges of the rolling stone. Typically, the linear velocity at the edge of the spinning cylindrical wheel that is closer to the center of flat bottom disc will be different and faster than the flat bottom disc surface. Similarly, the linear velocity at the edge of the spinning cylindrical wheel that is farther away to the center of flat bottom disc will be different but slower than the flat bottom disc surface. The difference in linear velocities between the flat bottom rotating disc surface and spinning cylindrical rollers will cause a crushing-shear action. In certain instances, this will help to provide more grinding operation. However, this effect is not desirable in many situations such as conching of cocoa paste, nut paste and sheer-sensitive biological products, herbal products, etc.

In some commercially available conventional stone grinders, such as melangers grinding cocoa mass into chocolate, the compressive force required to grind the product is provided by the weight of the granite roller stones (as in vintage melangers). In this design, the compressive force cannot be adjusted during operation. Alternatively, in some of the recent grinders, the compressive force is provided by a spring-compressed roller holder either inside the shaft or around the shaft. The configuration makes the design difficult to clean and perform maintenance which are important requirements in the food processing industry.

### BRIEF SUMMARY OF THE INVENTION

The present invention is directed to a series of different apparatus and processes for maintaining and adjusting control of compressive forces and is located outside of the grinding area. Also, variation and improvement is provided with respect to the relative velocity of rotating parts of a grinding machine used for grinding and conching cocoa beans and similar nuts and herbs, etc.

### BRIEF DESCRIPTION OF THE DRAWINGS

FIG. 1 discloses a gauge(s) for monitoring crushing forces created during the grinding process.

FIG. 2 is a fragmentary, plan view of a conventional, prior art, arrangement of a flat rotating bottom stone and a pair of cylindrical spinning stones.

FIG. 3 is a fragmentary plan view of a pair of conical spinning stones and a flat rotating bottom stone.

FIG. 3a is a fragmentary elevational view of the stones in FIG. 3.

FIG. 4 illustrates a pair of novel, sliced, cylindrical spinning stones.

FIG. 4a shows a modification of the stones in FIG. 4 wherein multiple grooves are cut on the sides of the thin, sliced grinding stones.

FIG. 5 is a side, elevational view of a design utilizing three conical stones with independent loading.

### DESCRIPTION OF THE PREFERRED EMBODIMENTS

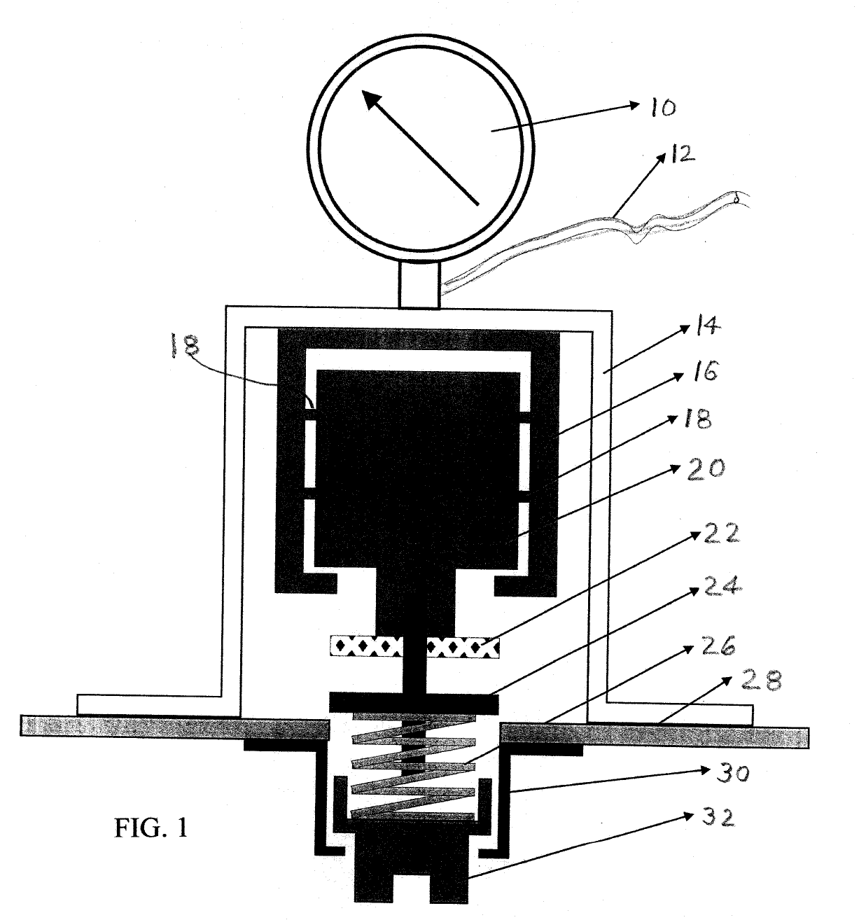

### Legend for FIG. 1:

10—Dial gauge indicator for compressive crushing force
12—Load cell and electrical leads from the load cell for optional digital display and control. The location of the load cell can alternatively be positioned on top of the compression spring
14—Compression gauge support frame
16—Piston housing
18—Piston O-rings
20—Piston block
22—Knurled nut to adjust the position of the piston block for zero reading
24—Support disc for compression spring guide
26—Compression spring
28—Swing arm support adjustment bar
30—Spring isolating housing outer sleeve
32—Compression spring coupler to connect to the rollers holder assembly shaft

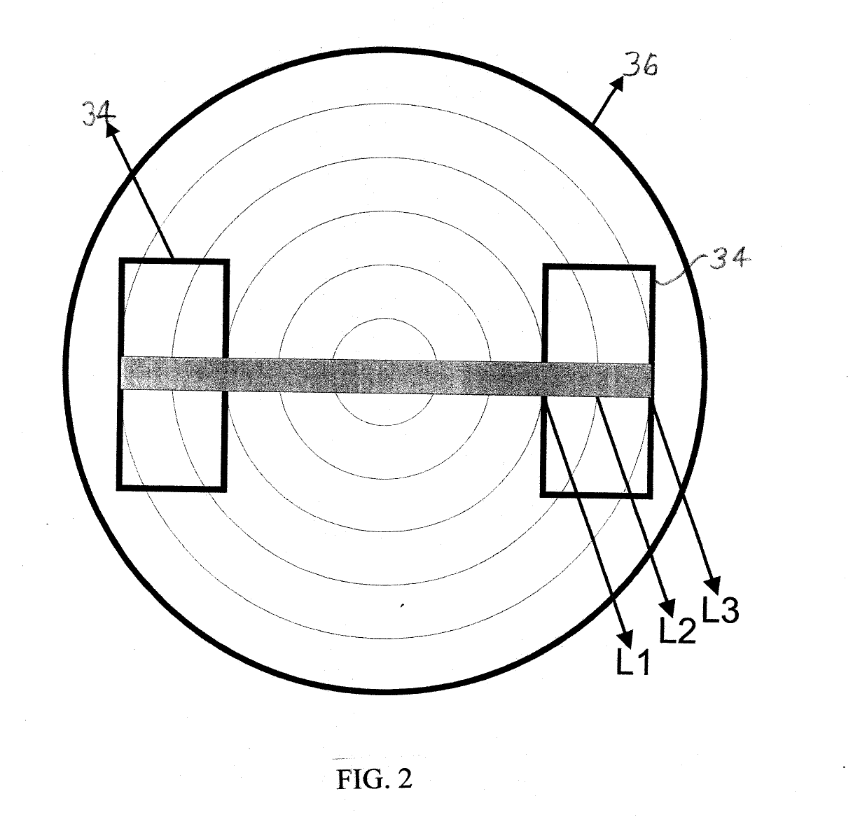

FIG. 1 discloses a compressive force measuring mechanism display including a dial gauge 10 and an optional load cell 12 for digital display and control. This force measuring gauge 10 or 12 and a force transmitting piston assembly comprised of a piston housing 16, piston o-rings 18, and a piston block 20 are attached to a support frame 14. The support frame 14 is attached to the swing arm 28 that has a hinge on one side and force adjusting screw on the other side (not shown). The bottom of the piston block 20 is connected to the top of a compression spring 26 through a compression spring top support disc 24, the position of which is adjustable by a knurled nut 22. The bottom end of the spring 26 is supported by a compression spring coupler 32 that is connected to a roller holder assembly shaft best shown in FIGS. 2, 3 and 4. The compression spring coupler 32 is guided by a spring isolating housing outer sleeve 30 that is attached to the swing arm bar 28.

As is shown in FIG. 1, the compression spring 26 is located inside of the housing in which the product is being ground and the spring 26 provides compressive force to the rollers (see FIGS. 2, 3 and 4) against the rotating base plate 36. The compressive force can be monitored and adjusted during operation and also can be reproduced precisely. The compressive force can be programmed to control the grinding and conching, for example, in cocoa processing.

Some of the benefits of isolating the spring assembly that provides the compressive crushing force are as follows: 1. The compression spring loaded force device is isolated from the food product and is easy to clean. 2. The spring loaded compression device is user adjustable in the pressure range and reproducible by spring selection and adjustable compression screw. With an hydraulic or pneumatic or mechanical screw or magnetic coupling, the compressive force can be continuously variable or programmable.

Another feature of the current invention is to provide apparatus for measuring the compressive crushing force acting on the product by the rollers. For optimum grinding process, it is critical to have a correct amount of crushing force/tension acting on the conical or cylindrical rollers. The compressive force monitoring component helps to monitor that force. The compressive force is measured and indicated by a pressure gauge and/or electronic load cell mechanism.

With use over time, the rollers, grinding base plate and other wearable parts will wear down. This happens very slowly, but can affect the optimum crushing force that can be applied to the rollers. This will lead to longer grinding times and less efficient grinding. The compressive force needs to be monitored and adjusted on a regular basis.

Some of the benefits of the compressive crushing force monitoring gauge are as follows:
1. The force monitoring gauge helps to adjust the grinding force to the optimum level for different process steps. During the grinding process, various compressive forces are preferred at different steps. For example, less force is preferred while adding nibs or pre-ground cocoa mass at the start. Optimum higher compressive crushing force is preferred during the subsequent particle size reduction process. Again, less force is required during the conching process later in the process.
2. Maintaining optimum crushing force increases the life of wearable components such as granite bottom stone plates and rollers. Applying higher than optimum force reduces the life span of wearable parts such as Delrin® bushings, granite parts, belt and gearbox components, while grinding time is not significantly reduced. It may also help to reduce the power consumption during the grinding process.
3. The gauge helps to control the batch consistency. Having consistent process helps to maintain final product quality and process/method transfer from development lab to the processing facility. It also helps with recording the batch records and standard operating procedures (SOPS) to maintain product quality and consistency.
4. The gauge helps to shorten the production cycle. If the compressive crushing force on the roller is less than optimum and if it is not measured and adjusted promptly, it may lead to inefficient longer grinding time.
5. The gauge will help for trouble shooting and identifying proper maintenance cycle. If sufficient force cannot be provided with force control device, the grinder may call for recommended maintenance. The grinding performance will be significantly improved after proper maintenance.

FIG. 2 illustrates a conventional arrangement of a pair of cylindrical grinding stones 34 that are disposed above a flat rotating bottom stone 36. The stones 34 spin during a grinding operation. Placement of the stones 34 at different radii of the bottom stone 36 varies the relative velocity.

At radius L1 of the flat bottom stone 36, the linear velocity of the cylindrical stone 34 will be higher relative to the connecting line in the flat bottom disc, resulting in a high shear condition.

At radius L3 of the flat bottom stone 36, the linear velocity of the cylindrical stone 34 will be lower relative to the connecting line in the flat bottom disc, also resulting in a high shear condition.

At radius L2 of the flat bottom stone 36, the linear velocity of the cylindrical stone 34 will be approximately equal to the linear velocity of the connecting line in the flat bottom disc, resulting in a minimum shear condition.

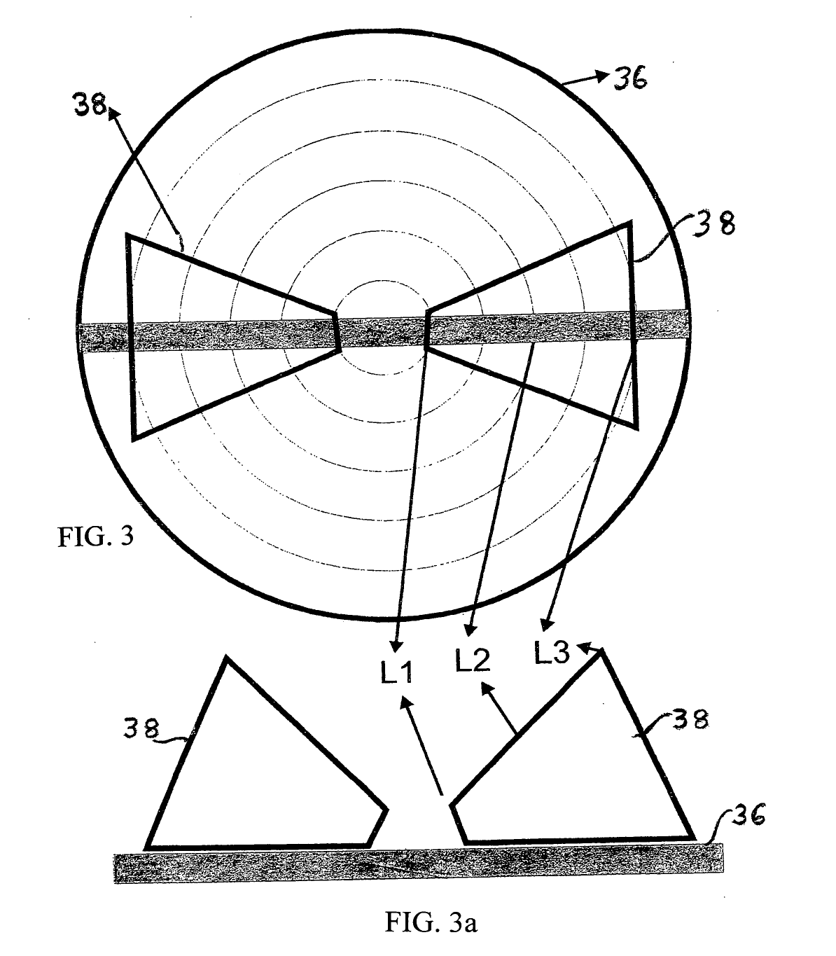

The plan view of FIG. 3 and the elevational view of FIG. 3a are useful in explaining the improvement provided by using conical spinning grinding stones 38 with the flat, rotating bottom stone 36. At radius L1, L2 and L3 of the flat circular bottom stone 36, the linear velocity of the conical spinning stones 38 will be approximately equal to the velocity of the connecting line in the flat bottom disc, thus resulting in a minimum shear condition at all radius lines.

As shown in FIG. 3 in the conical spinning wheel design, the linear velocities across the height of the cone will be comparable to the contact line at the bottom rotating disc surface. The conical shape roller stones will produce primarily crushing action with no shearing action, whereas cylindrical roller will produce both crushing and crushing-shear forces during grinding. In this conical wheel design, the crushing-shear action is minimized along the length of the contact line and this configuration is desirable for grinding products that are shear and temperature sensitive. However, the manufacturing process for a conical spinning wheel is complicated, expensive and requires high precision.

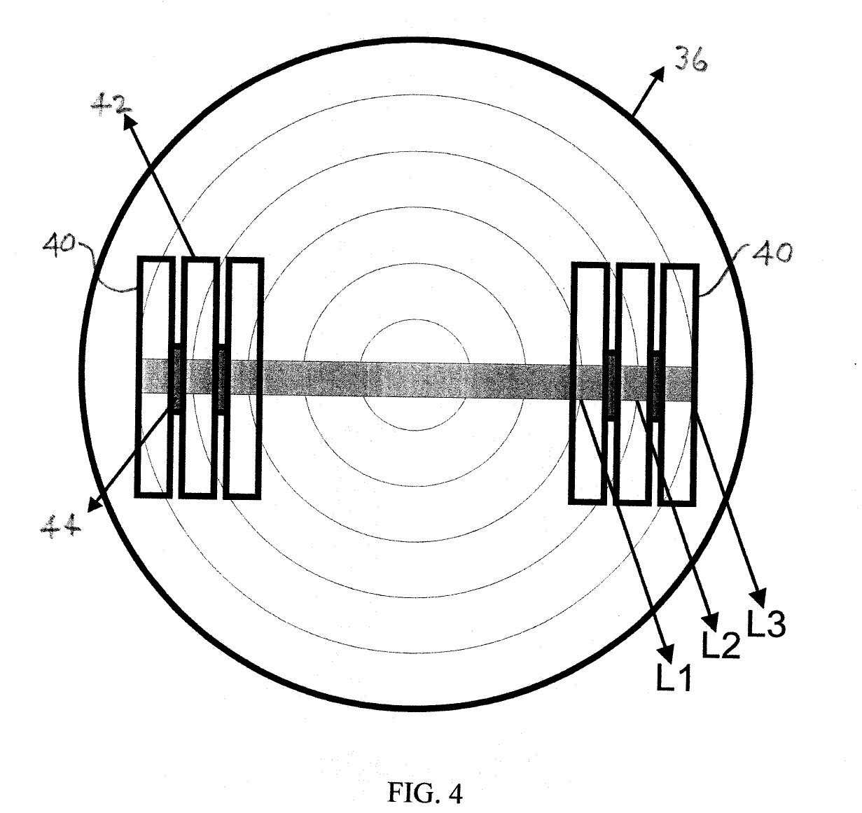

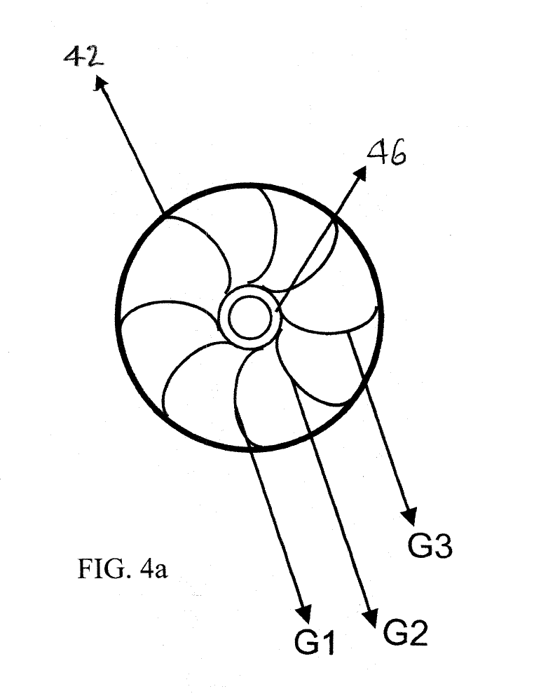

In the present invention, as shown in FIG. 4, the spinning cylindrical wheel is sliced into multiple thin spinning wheels and grouped together with spacers in between the sliced wheels. In this configuration, linear velocity of each slice of the spinning group will be different depending upon the position of the slice and will closely match the linear velocity of the contact circle line of the bottom rotating disc surface. In this design, the differential liner velocities of the spinning wheel and the bottom rotating disc is minimum. Therefore, the crushing-shear action is minimized and crushing-shear heat will be minimum. With this sliced cylindrical wheel design, the amount of crushing-shear can be adjusted by the width of the sliced wheel. Therefore, it is desirable to have multiple narrow cylindrical wheels with proper spacing between them rather than one wide cylindrical wheel to reduce crushing-shear action. These sliced wheels are easy to manufacture and maintain. The gap between the slices can be adjusted by the thickness of the spacers between them.

If simple shearing action is desired, such effect can be produced by keeping the thin cylindrical rollers close to each other where the product will be exposed to non-crushing-shear action in the gap between cylindrical rollers. Therefore, the relative ratio of grinding with and without simple shearing can be widely adjusted just by adjusting the gap between the thin cylindrical rollers. For example, during initial stages of the cocoa processing, the gap can be adjusted to small where crushing-shear induced grinding is caused between roller wheel and bottom plate. After sufficient grinding is achieved, the gap between the cylindrical rollers can be adjusted to optimize the non-crushing-shear while significantly increasing the mixing action promoting conching effect.

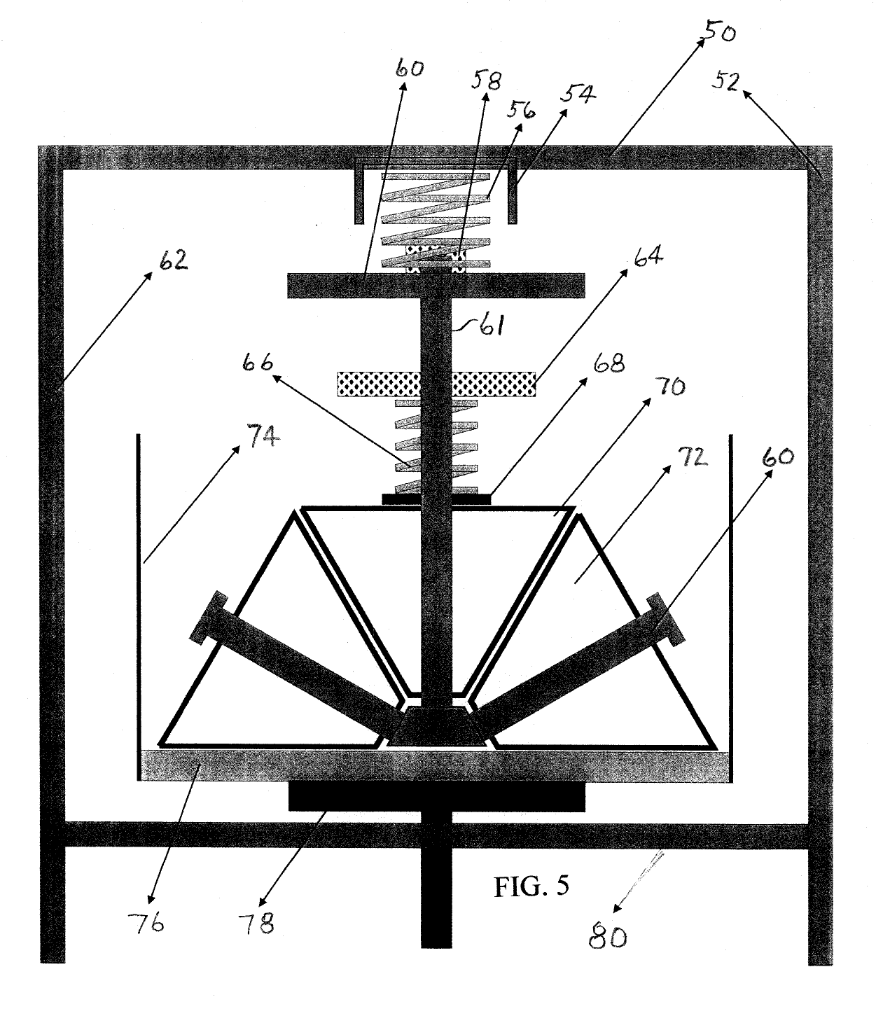

In FIG. 4a, multiple grooves G1, G2, G3 etc., of different shapes, lengths and depths are cut on the sides of the thin sliced grinding stones 42. These grooves G1, etc., are designed to move the product from the circumference toward support shaft 46 at the center of the thin stones 42, or from the center to the circumference depending upon the configuration and rotation direction of the bottom flat stone 36. FIG. 5 shows a three roller design of a grinding assembly comprised of three conical rollers with mechanism to provide independent crushing forces acting between the rollers and the bottom flat plate.

### Legend for FIG. 5:

50—Top swing arm support
52—Right side chassis support
54 —Spring housing
56 —Primary spring
58 —Small knurled nut
60 —Rollers holder assembly
62 —Left side chassis support
64 —Large knurled nut
66 —Middle secondary roller spring
68 —Spring support washer
70 —Middle roller
72 —Main side rollers (left and right side)
74 —Vessel container
76 —Bottom grinding surface
78 —Vessel support/drive flange
80 —Motor housing top

In this embodiment, the grinding vessel is comprised of a bottom grinding surface 80 attached to the grinding vessel 74. The grinding vessel is supported by the flange 78 which is driven by a geared motor (not shown) located inside the motor housing 80. The top swing arm 50 is supported and connected to the motor housing by left side chassis support 62 and right side chassis support 52. The spring housing 54 is comprised of fixed and movable sleeves and holds the primary spring 56. The roller holder assembly 60 is the main support structure that holds all three conical rollers—left side roller 72, right side roller 72, and middle conical roller 70. The force on the middle roller 70 exerted onto the right and left side rollers 72 is provided by the middle secondary roller spring 66 supported by the spring support washer 68 and controlled by the large knurled nut 64. The small knurled nut 58 is used to assemble all the components of the rollers holder assembly and guides the primary spring 56.

The pressure on the primary spring 56 is controlled by the position of the spring housing 54 using the swing arm 50. The crushing force acting the product mass trapped between the side rollers 72 and bottom grinding surface 76 is provided by the primary spring 56. This force can be measured by a pressure gauge assembly (such as shown in FIG. 1). The pressure acting on the product trapped between middle roller 70 and side rollers 72 is provided by the middle secondary spring 66. These crushing forces can be independently adjusted and controlled. The product is constantly mixed by a wiper assembly (not shown in the diagram) that is attached to the main roller holder assembly shaft 61.

While the invention has been described in connection with preferred embodiments, it is not intended to limit the scope of the invention to the particular form set forth; on the contrary, it is intended to cover such alternatives, modifications, and equivalents that may be included within the spirit and scope of the invention as defined by the appended claims.

1. A multi-purpose food grinding machine comprising a spring loaded pressuring mechanism for exerting compressive force upon grinding rollers for grinding product,
said grinding rollers being located outside the spring housing, inside of said housing to avoid contamination of the said food product.

2. The multi-food grinding machine as defined in claim 1 including means connected to said spring loaded mechanism for adjusting said compressive force.

3. The multi-purpose food grinding machine as defined in claim 1 including a pressure monitor attached to said grinding rollers for measuring said compressive force exerted upon said grinding rollers, and said pressure monitor being located outside of said housing.

4. A multi-purpose food grinding machine including at least one grinding roller, said grinding roller having a conical shape, and means mounting said grinding roller adjacent to a flat rotatable grinding stone wherein the linear velocity of said stone matches the linear velocity of said grinding roller.

5. A grinding roller for multi-purpose food grinding machine, said grinding roller being comprised of a plurality of multiple sliced roller segments grouped in spaced relation to each other.

6. A grinding roller as defined in claim 5 wherein sides of said sliced roller segments are provided with grooves for moving product radially thereof.

7. The grinding roller as defined in claim 5 wherein sliced roller segments are spaced from each other a distance of 0.1 to 5.0 mm.

8. The grinding roller as defined in claim 5 wherein the thickness of said roller segments is between 5 mm and 30 mm.

9. A multi-purpose food grinding machine as defined in claim 1 wherein said grinding rollers are comprised of three conical shaped rollers, and an adjustable spring loaded mechanism for adjusting the crushing force exerted between said rollers.
